(19) United States
(12) Patent Application Publication
(10) Pub. No.: US 2026/0259759 A1
(43) Pub. Date: Sep. 3, 2026

(54) VIRTUAL MACHINE SWITCHING METHOD, DATA STORAGE METHOD, DEVICE, PROCESSOR, AND STORAGE MEDIUM

(71) Applicant: CLOUD INTELLEIGENCE ASSETS HOLDING (SINGAPORE) PRIVATE LIMITED, Singapore (SG)

(72) Inventors: Zhenning WANG, Shanghai (CN); Ben LUO, Shanghai (CN)

(73) Assignee: CLOUD INTELLEIGENCE ASSETS HOLDING (SINGAPORE) PRIVATE LIMITED, Singapore (SG)

(21) Appl. No.: 19/163,841

(22) PCT Filed: Jan. 25, 2024
(86) PCT No.: PCT/CN2024/074065

§ 371 Date: Sep. 9, 2025

(30) Foreign Application Priority Data
Oct. 3, 2023 (CN) 202310264147.0

(51) Int. Cl. G06F 9/455

(52) U.S. Cl. CPC G06F 9/45558; G06F 2009/45575

(57) ABSTRACT

Embodiments of this disclosure provide a virtual machine switching method, a data storage method, a device, a processor, and a storage medium. In the embodiments of the present disclosure, a dedicated cache dedicated to caching status data of virtual machines is provided in a cache of a processor. On the basis of the dedicated cache, when an execution flow of the processor is switched from a host to a target virtual machine, the state data of the target virtual machine can be read from the dedicated cache of the processor.

### CROSS REFERENCE TO RELATED APPLICATIONS

This disclosure is a National Stage of International Application PCT/CN2024/074065 filed on Jan. 25, 2024, which claims priority to Chinese Patent Application No. 202310264147.0, filed on Mar. 10, 2023 and entitled “VIRTUAL MACHINE SWITCHING METHOD, DATA STORAGE METHOD, DEVICE, PROCESSOR, AND STORAGE MEDIUM”, the entire contents of the mentioned applications are incorporated herein by reference in their entireties.

### TECHNICAL FIELD

This disclosure relates to the field of computer technologies, and in particular, to a virtual machine switching method, a data storage method, a device, a processor, and a storage medium.

### BACKGROUND

The virtual machine (VM) is a computer system that is simulated by software and that has a complete hardware system function and runs in an isolated environment. During scheduling of a current virtual machine, when switching from the virtual machine to a host (Host), the current virtual machine needs to be exited (that is, vmexit) first, and status data of the current virtual machine is stored into a main memory. After operations on the host are completed, switching needs to be performed from the host back to the exited virtual machine or to another virtual machine. This process requires that the host read status data of a to-be-run virtual machine from the main memory of the host to a central processing unit (CPU), and finally run the virtual machine (that is, vmenter) based on the status data of the to-be-run virtual machine. The foregoing virtual machine scheduling procedure is a complete virtual machine switching process, and the virtual machine switching process consumes long time, resulting in low virtual machine switching efficiency.

### SUMMARY

A plurality of aspects of this disclosure provide a virtual machine switching and data storage method, a device, a processor, and a storage medium, to improve the virtual machine switching efficiency.

An embodiment of this disclosure provides a virtual machine switching method, including: obtaining status data of a to-be-run target virtual machine from a dedicated cache of a processor in response to a virtual machine scheduling event, where the dedicated cache is a partial cache of the processor, and is configured to store status data of a virtual machine; switching an execution flow of the processor from a host of the target virtual machine to the target virtual machine; and running the target virtual machine based on the status data of the target virtual machine.

An embodiment of this disclosure further provides a data storage method. A processor of a host includes a dedicated cache, where the dedicated cache is configured to store status data of a virtual machine. The method includes: determining a to-be-cached target virtual machine from the host; obtaining status data of the target virtual machine from a main memory of the host; and storing the status data of the target virtual machine into the dedicated cache, in a way that the status data stored in the dedicated cache is available to switch an execution flow of the processor to the target virtual machine.

An embodiment of this disclosure further provides a computing device, where one or more virtual machines are deployed on the computing device. The computing device includes a processor, the processor includes a control unit, a computing unit, and a cache; and the computing device further includes a target memory, configured to store a computer program. The cache includes a dedicated cache and a shared cache; the dedicated cache is configured to store status data of the virtual machines; and the shared cache is configured to execute other data required for executing the computer program than the status data of the virtual machines. The control unit is coupled to the computing unit, the cache, and the target memory, and the control unit is configured to: execute the computer program; write the other data into the shared cache when executing the computer program; and perform steps in the foregoing virtual machine switching method and/or data storage method with reference to the other data.

An embodiment of this disclosure further provides a processor, including: a control unit, a computing unit, and a cache. The cache includes: a dedicated cache and a shared cache. When the processor is deployed in an electronic device, the dedicated cache is configured to cache status data of one or more virtual machines deployed on the electronic device; and the shared cache is configured to cache other data required for running a computer program on the electronic device other than the status data of the virtual machines. The control unit is coupled to the cache and the computing unit, and the control unit is configured to invoke, from a memory of the electronic device on which the processor is deployed, a computer program stored in the memory and run the computer program, to enable the electronic device to perform steps in the foregoing virtual machine switching method and/or data storage method.

An embodiment of this disclosure further provides a computer-readable storage medium storing computer instructions, where when the computer instructions are executed by one or more processors, the one or more processors are enabled to perform steps in the foregoing virtual machine switching method and/or data storage method.

### BRIEF DESCRIPTION OF DRAWINGS

In the drawings, unless otherwise specified, same reference numerals throughout a plurality of drawings represent same or similar parts or elements. These drawings are not necessarily drawn to scale. It should be understood that these drawings only describe some embodiment disclosed according to this disclosure, and should not be construed as limitations to the scope of this disclosure.

The accompanying drawings described herein are used to provide a further understanding of this disclosure, and form a part of this disclosure. Exemplary embodiments of this disclosure and descriptions thereof are used to explain this disclosure, and do not constitute any inappropriate limitation to this disclosure. The following FIG. 1 to FIG. 6 are included in the accompanying drawings.

FIG. 1 is a schematic diagram of a structure of a computing device according to an embodiment of this disclosure.

FIG. 2 is a schematic diagram of a deployment position of a dedicated cache according to an embodiment of this disclosure.

FIG. 3 is a schematic diagram of a virtual machine switching process according to an embodiment of this disclosure.

FIG. 4 is a schematic flowchart of a virtual machine switching method according to an embodiment of this disclosure.

FIG. 5 is a schematic flowchart of a data storage method according to an embodiment of this disclosure.

FIG. 6 is a schematic diagram of a structure of a computing device according to an embodiment of this disclosure.

### DETAILED DESCRIPTION

To make objectives, technical solutions, and advantages of this disclosure clearer, the technical solutions of this disclosure will be clearly and completely described below with reference to specific embodiments of this disclosure and the accompanying drawings. Apparently, the described embodiments are only some embodiments rather than all the embodiments of this disclosure. All other embodiments obtained by a person of ordinary skill in the art based on the embodiments of this disclosure without creative efforts shall fall within the protection scope of this disclosure.

It is found in this disclosure through a research on a current virtual machine scheduling procedure that, in the current virtual machine scheduling procedure, a complete process of virtual machine exit (vmexit) and virtual machine launch (vmlaunch) consumes approximately 2000 clock cycles (cycles), where execution of a virtual machine exit (vmexit) instruction and a virtual machine launch (vmlaunch) instruction consumes approximately 200 to 300 clock cycles. The clock cycle is a clock cycle of a processor of a host of the virtual machine.

In some solutions, to improve a virtual machine switching speed, a paravirtualization (PV) technology or an input/output (IO) device passthrough technology is applied in an operating system, to reduce the number of times of virtual machine exit, that is, reduce the number of times of executing the vmexit instruction. This is mainly because for an IO device passthrough technology, a virtual machine can directly access a main memory to read status data of the virtual machine, and virtual machine exit does not need to be performed. The paravirtualization technology refers to a method in which a virtual machine system cooperates with a host system to virtualize a virtual machine system. In this technology, the virtual machine can access a main memory by using a virtualized IO device to read data, and the number of times of virtual machine exit can also be reduced.

However, for the paravirtualization technology and the IO device passthrough technology, when scheduling the virtual machine, the operating system still needs to return to a host by using a virtual machine exit instruction (such as the vmexit instruction). This is mainly because in a running process of the virtual machine, the host may have an instruction that needs to be executed. Therefore, the running of the virtual machine needs to be interrupted by using a timer interrupt technology, and a switch to the host is performed to check whether there is an instruction that needs to be executed. Therefore, time overheads of virtual machine exit still exist in the paravirtualization technology and the IO device passthrough technology. It is found in this disclosure through research that the time overheads of virtual machine exit (vmexit) are approximately 1000 times per second in the paravirtualization technology and the IO device passthrough technology.

It is found in this disclosure through research that performance of the virtual machine switching procedure is closely related to a processor cache, and time overheads of virtual machine switching when the processor cache has status data of a related virtual machine are approximately one tenth of time overheads of virtual machine switching when the processor cache does not have status data of a related virtual machine.

Based on this, in some embodiments of this disclosure, to improve virtual machine switching efficiency, a dedicated cache dedicated to caching status data of a virtual machine is disposed in a cache of a processor. Based on the dedicated cache, when an execution flow of the processor is switched from a host to a target virtual machine, status data of the target virtual machine can be read from the dedicated cache of the processor. In comparison with the conventional method of reading status data of a virtual machine from a main memory during virtual machine switching, a speed of reading the status data of the virtual machine from the cache is higher. Therefore, reading the status data from the dedicated cache of the processor during virtual machine switching helps improve virtual machine switching efficiency.

The following describes the technical solution provided in embodiments of this disclosure in detail with reference to the accompanying drawings.

It should be noted that, similar numerals in the following accompanying drawings and embodiments indicate similar items. Therefore, once an item is defined in one accompanying drawing or embodiment, the item does not need to be further discussed in the subsequent accompanying drawings and embodiments.

FIG. 1 is a schematic diagram of a structure of a computing device according to an embodiment of this disclosure. As shown in FIG. 1, the computing device includes a processor 10. The processor 10 may include: a control unit 101, a cache 102, and a computing unit 103.

The control unit 101 is a control center of the processor 10, and includes an instruction register (IR), an instruction decoder (ID), an operation controller (OC), and the like. The control unit 101 may sequentially fetch instructions from a memory according to a pre-written computer program, place the instructions in the instruction register (IR), determine a corresponding operation by decoding the instruction, and then send a micro operation control signal to a corresponding component according to a determined time sequence by using the operation controller (OC). The control unit 101 may control, by using control instructions, working of the cache 102 and the computing unit 103.

The computing unit 103 is a core of the processor 10, and may perform an arithmetic operation and a logical operation. The computing unit 103 receives a command of the control unit to perform an action, in other words, all operations performed by the computing unit 103 are instructed by control signals sent by the control unit 101, and the computing unit 103 is an instruction execution component.

The cache 102 is a storage unit that temporarily stores data in the processor 10, and is configured to store data that is waiting to be processed or data that has been processed. Time used by the processor 10 to access the cache 102 is shorter than time used to access a main memory. By using the cache 102, the number of times of accessing the main memory by the processor 10 can be reduced, thereby improving a data processing speed of the processor 10.

In this embodiment, the computing device may further include a target memory 20. The target memory 20 refers to a storage medium other than the cache 102 on the computing device. The target memory 20 may include: a main memory 201, a non-volatile storage medium 202, and the like. The non-volatile storage medium may be a magnetic disk, a solid-state drive, or the like.

In this embodiment, the target memory 20 stores a computer program. For example, the computer program may be stored in the main memory 201.

In this embodiment, the computing device is a host of a virtual machine (VM) 30, and may be a server device. For example, the computing device may be a single server device, or may be a cloudified server array. Certainly, the computing device may alternatively be a terminal device such as a mobile phone, a tablet computer, a personal computer, or a wearable device.

In this embodiment, the virtual machine 30 is deployed on the computing device. The virtual machine 30 may also be referred to as a virtual machine (guest) of the host. The VM 30 is provided with an independent processor (such as a CPU), a main memory, a network, a magnetic disk, and the like. The CPU corresponding to the virtual machine 30 may also be referred to as a virtual CPU (vCPU). There may be one VM 30 or a plurality of VMs 30 deployed on the computing device. “A plurality of” means two or more. Each VM may have a logic core, or a plurality of VMs 30 may share a logic core.

For a processor (such as a CPU), a physical core is a physical resource of the processor. The logical core is a logical processing unit obtained by virtualizing the physical core by using a hyper-threading technology. The vCPU is a concept proposed during virtualization, usually refers to a CPU logic core, and is obtained by dividing a logic core according to a virtual ratio. The virtual ratio is a ratio of a quantity of vCPUs obtained by virtualizing one logical core. For example, the virtual ratio is 1:100, indicating that one logic core is virtualized into 100 vCPUs. vCPUs corresponding to a plurality of VMs share a same logic core, and this type of VM is a sharing VM.

In a running process of a VM, a switch from a currently running VM to a host is usually required, and after the host performing an operation, a switch from the host to the VM is performed, that is, VM switching is performed. When executing the computer program, the processor 10 may read, from the main memory 201, data required for executing the computer program into the cache 102. Because a data transmission rate of the cache 102 is higher than that of the main memory 201, data required for the computer program is stored in the cache 102, thereby helping improve data processing efficiency of the processor 10. In the embodiments of this disclosure, for an application scenario of virtual machine switching, status data of a to-be-run virtual machine may be stored in the cache 102, to improve data processing efficiency of the processor 10.

Because storage space in the cache 102 is limited, the storage space in the cache 102 is usually much smaller than storage space of the main memory 201. During execution of the computer program by the processor 10, data stored in the cache 102 usually needs to be exchanged in or out. Even if the cache 102 stores status data of a virtual machine, the status data of the virtual machine may be overwritten by other data during execution of the computer program. Consequently, it cannot be ensured that the status data of the virtual machine is always stored in the cache 102. For a case in which the status data of the virtual machine stored in the cache 102 is overwritten by other data, when the virtual machine switching is performed, the status data of the virtual machine needs to be read from the main memory 201, which still affects virtual machine switching efficiency.

To reduce a risk that the status data of the virtual machine is overwritten by other data, in this embodiment, a dedicated cache space may be set in the cache 102, namely, a dedicated cache 102a, configured to store the status data of the virtual machine. The dedicated cache 102a is specially configured to store the status data of the virtual machine, and other data required for executing the computer program is not stored in the dedicated cache 102a.

In this embodiment, a storage medium whose data transmission efficiency is higher than that of the main memory 201 is used as the dedicated cache 102a. For example, if the main memory 201 is a double data rate synchronous dynamic random access memory (DDR SDRAM), DDR memory for short, a static random access memory (SRAM) may be used as the dedicated cache 102a. If the main memory 201 is a phase-change memory (PRAM), a DDR memory or the like may be used as the dedicated cache 102.

The dedicated cache 102a may be a partial cache obtained by dividing an inherent cache of the processor 10. In other words, a partial cache of the inherent cache of the processor 10 is set as the dedicated cache 102, and is dedicated to storing the status data of the virtual machine. Correspondingly, a cache other than the dedicated cache 102a in the inherent cache of the processor 10 is a shared cache 102b. The shared cache 102b may store, during execution of the computer program, the other data required for the computer program than the status data of the virtual machine, to support data exchange in and out.

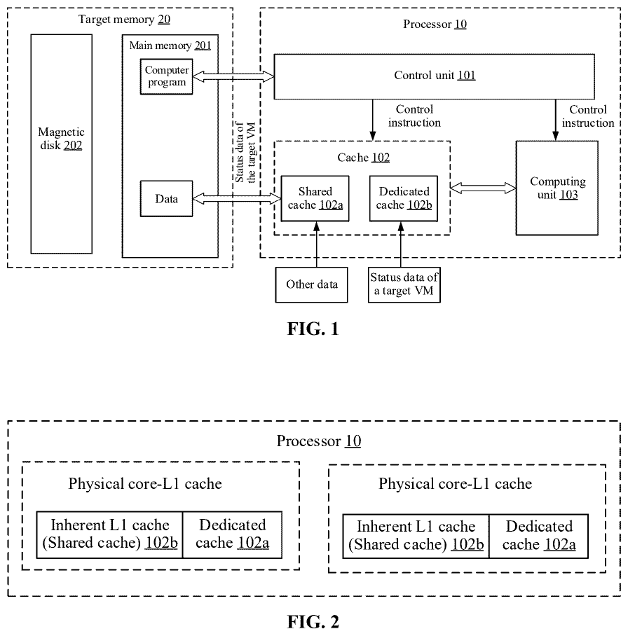

Certainly, as shown in FIG. 2, the dedicated cache 102a may alternatively be a cache newly added to the processor 10 in addition to the inherent cache of the processor 10. The newly added cache is used as the dedicated cache, and is dedicatedly used for storing the status data of the virtual machine. The inherent cache of the processor 10 is the shared cache 102b, and may store, during execution of the computer program, the other data required for the computer program than the status data of the virtual machine, to support data exchange in and out.

In this embodiment, the dedicated cache 102a and the shared cache 102b jointly constitute the cache 102 of the processor 10. The cache 102 may include multi-level caches. For example, the cache 102 may include: a first-level (L1) cache, a second-level (L2) cache, and a third-level (L3) cache. Correspondingly, the shared cache 102b may also include an L1 cache, an L2 cache, and an L3 cache. The dedicated cache 102a may also include an L1 cache, an L2 cache, and an L3 cache. Certainly, the dedicated cache 102a may alternatively be set in any level of the L1 cache, the L2 cache, and the L3 cache. As shown in FIG. 2, to improve data transmission efficiency, the dedicated cache 102a may be set in the L1 cache.

In this embodiment, a size of storage space of the dedicated cache 102a is not limited. For example, the storage space of the dedicated cache 102a is a positive integer multiple (for example, N times) of a data volume of status data (set to Y kB) of a single virtual machine. N ≥1, and is an integer. In this case, the storage space of the dedicated cache 102a may be N*Y kB. The dedicated cache 102a may be divided into N cache spaces based on the data volume of the status data of the single virtual machine. Each cache space is configured to store status data of one virtual machine. In this embodiment, a corresponding identifier such as idx may be set for each cache space. x=0, 1, . . . , (N−1). idx may indicate an x^{th} cache space in the dedicated cache 102a.

In this embodiment, to implement reading and writing of the dedicated cache, a new instruction is added to the processor 10, and the instruction is used for managing the dedicated cache. The new instruction may specify which cache space in the dedicated cache 102a to store data of which main memory address. For example, the newly added instruction may be: “vmcs_cache_addr idx addr”. “idx” in the instruction indicates a cache space identified as idx in the dedicated cache. “addr” represents a main memory start address of to-be-stored data. Correspondingly, the instruction “vmcs_cache_addr idx addr” indicates to write data in a main memory space with a main memory address [addr, addr+Y kB] into the cache space identified as idx in the dedicated cache 102a.

In this embodiment, the control unit 101, the cache 102, and the computing unit 103 are electrically connected to each other. The processor 10 is electrically connected to the target memory 20. In this embodiment, the control unit 101 may be coupled to the cache 102, the computing unit 103, and the target memory 20, to execute the computer program stored in the target memory 20. For example, in the process of controlling the computing unit 102 to execute the computer program, the control unit 101 may write the computer program and other data required for the computer program into the shared cache 102b, and perform the method for storing status data of a virtual machine with reference to the other data in the shared cache 102b.

The following exemplarily describes the method for storing status data of a virtual machine from a perspective of the processor. To implement VM switching acceleration, based on the dedicated cache 102a, the processor 10 may determine a to-be-cached target virtual machine from the computing device. The to-be-cached target virtual machine is a virtual machine whose status data needs to be stored in the dedicated cache 102a.

In this embodiment, a specific implementation of determining the to-be-cached target virtual machine is not limited. In some embodiments, the processor 10 may determine, according to a set cache management policy, the target virtual machine from virtual machines deployed on the computing device. For example, the processor 10 may select, based on switching frequencies of the virtual machines in the computing device, a virtual machine whose switching frequency meets a set cache condition from the virtual machines deployed on the computing device as the to-be-cached target virtual machine. The cache condition corresponding to the switching frequency may be implemented as that: the switching frequency is greater than or equal to a set frequency threshold. Correspondingly, a virtual machine whose switching frequency is greater than or equal to the set frequency threshold may be selected from the virtual machines deployed on the computing device as the to-be-cached target virtual machine.

Alternatively, for the switching frequency, the set cache condition may be implemented as that: a virtual machine whose switching frequency is the highest switching frequency among the virtual machines is selected. Correspondingly, the virtual machine having the highest switching frequency may be selected from the virtual machines deployed on the computing device as the to-be-cached target virtual machine.

In some other embodiments, a virtual machine whose number of use times meets a set cache condition may be selected from the virtual machines deployed on the computing device based on numbers of use times of the virtual machines in the computing device within a set time period, and used as the to-be-cached target virtual machine. The cache condition corresponding to the number of use times may be implemented as that: the number of use times within the set time period is greater than or equal to a set number of times threshold. Correspondingly, a virtual machine whose number of use times in the set time period is greater than or equal to the set number of times threshold may be selected from the virtual machines deployed on the computing device as the to-be-cached target virtual machine.

Certainly, in some other embodiments, all virtual machines deployed on the computing device may alternatively be used as to-be-cached target virtual machines; or any virtual machine in the computing device is used as the to-be-cached target virtual machine.

The foregoing implementations of determining the to-be-cached target virtual machine shown in the foregoing embodiment is merely an exemplary description, and does not constitute a limitation.

For the to-be-cached target virtual machine, the processor 10 may obtain status data of the target virtual machine from the target memory 20. For example, the processor 10 may obtain the status data of the target virtual machine from the main memory 201.

In the embodiments of this disclosure, status data of a virtual machine refers to data required for running of the virtual machine, and includes, but is not limited to: status data of a register, a main memory page table of the virtual machine, and the like during running of the virtual machine. In some processor architectures, the status data of a virtual machine may be implemented as a virtual machine control structure (VMCS). In some other processor architectures, the status data of a virtual machine may be implemented as a context of a processor, and the like.

For the processor 10, a main memory address corresponding to the target virtual machine may be determined based on an identifier of the target virtual machine. The main memory address may be a virtual address of a host. The status data of the target virtual machine is stored in the main memory address corresponding to the target virtual machine. Correspondingly, the processor 10 may read the status data of the target virtual machine from the main memory 201 based on the main memory address corresponding to the target virtual machine.

In some implementations, the processor 10 may store the status data of the target virtual machine into the dedicated cache 102a. In this way, when an execution flow of the processor is subsequently switched from the host to the target virtual machine, the status data of the target virtual machine can be directly read from the dedicated cache 102a, helping improve the virtual machine switching efficiency.

An execution flow of a processor is a segment of logically independent instruction area. Execution flows are independent, and each execution flow has its own stack and a set of its own register image and main memory resource, that is, each execution flow has an independent context. The execution flow of a processor may include: an instruction sequence currently run by the processor, a register status of the processor, and the like.

In the embodiments of this disclosure, when storing the status data of the target virtual machine into the dedicated cache 102a, the processor 10 may determine a target cache space from the dedicated cache 102a, and write the status data of the target virtual machine into the target cache space.

In some embodiments, the processor 10 may determine an idle cache space from the dedicated cache as the target cache space.

In some other embodiments, there may be no idle cache space in the dedicated cache. Correspondingly, the processor 10 may determine a to-be-replaced cache space from the dedicated cache 102a as the target cache space according to a set cache replacement algorithm. Certainly, the implementation of determining the to-be-replaced cache space by using a cache replacement algorithm is also applicable to a case in which there is an idle cache space stored in the dedicated cache.

In the embodiments of this disclosure, the cache replacement algorithm is used to provide a policy for determining the to-be-replaced cache space, and a specific implementation form of the cache replacement algorithm is not limited. For example, the cache replacement algorithm may include: an optimal replacement (OPT) algorithm, a first in first out (FIFO) algorithm, a least recently used (LRU) algorithm, a clock replacement (CLOCK) algorithm, or the like.

The optimal replacement algorithm (OPT) means selecting a cache space that is never used subsequently or that is no longer accessed in the longest time, and using the cache space as the to-be-replaced target cache space.

The first in first out (FIFO) algorithm means arranging cache spaces in a dedicated cache into a queue according to a sequence of data writing, and selecting a cache space into which data is first written as the to-be-replaced target cache space.

The least recently used (LRU) algorithm means that the selected cache space is a cache space that has not been used recently. In an embodiment, an access field may be used to record time elapsed since a cache space in the dedicated cache was accessed last time. When cache replacement needs to be performed, a cache space with the largest corresponding time value is selected from the cache spaces as the cache space that has not been used recently, that is, the to-be-replaced target cache space.

The clock replacement algorithm (CLOCK) means that cache spaces in the dedicated cache are linked to a pointer to form a cyclic queue, and an access bit field is added for each cache space. When a cache space is accessed, an access bit field corresponding to the cache space is also set to 1. In the method, when cache replacement needs to be performed, an operating system scans a buffer zone, to search for a cache space whose corresponding access bit field is set to 0, and uses a cache space first found through scanning whose corresponding access bit field is set to 0, as the to-be-replaced target cache space.

After determining the target cache space, the processor 10 may write the status data of the target virtual machine into the target cache space.

Because the dedicated cache is a dedicated cache for the status data of the virtual machine, a processor instruction for managing the dedicated cache may be added to the processor, for example, the instruction “vmcs_cache_addr idx addr” shown in the foregoing embodiment. After the to-be-cached target virtual machine and the target cache space in the dedicated cache are determined based on the processor instruction for managing the dedicated cache, the processor 10 may write the main memory address of the target virtual machine and the identifier of the target cache space into the processor instruction according to a format of the processor instruction for managing the dedicated cache. The processor instruction may include: the main memory address of the status data of the target virtual machine and the identifier of the target cache space.

In an embodiment, the processor 10 may execute the processor instruction for managing a dedicated cache, and read the status data of the target virtual machine from the main memory according to the main memory address included in the processor instruction when executing the processor instruction. For example, the status data of the target virtual machine may be read from a main memory space whose main memory address is [addr, addr +Y KB].

For example, when executing the processor instruction, the processor 10 may write the status data of the target virtual machine into the cache space corresponding to the identifier of the target cache space in the dedicated cache. For example, the processor 10 may write the status data of the target virtual machine into a cache space corresponding to an identifier of the target cache space in the dedicated cache based on a data structure corresponding to the dedicated cache. The data structure corresponding to the dedicated cache may be VMCS.

Because the status data of the target virtual machine is stored in the dedicated cache 102a in the processor 10, when the execution flow of the processor 10 is switched from the host to the target virtual machine, the status data of the target virtual machine can be read from the dedicated cache 102a, helping improve the virtual machine switching efficiency.

The virtual machine switching process provided in the embodiments of this disclosure is exemplarily described below. In the embodiments of this disclosure, a virtual machine switching scenario may include: the execution flow of the processor exits from VM1, and is switched to a host on which VMI is located; and then, is switched back from the host to VM1. Certainly, the virtual machine switching scenario may alternatively include: the execution flow of the processor exits from VM1, and is switched to a host on which VMI is located; and then, is switched from the host to VM2. Whether the execution flow of the processor is switched from the host back to VM1 or to VM2 is specifically determined by the operating system scheduling in the processor 10.

For example, the processor 10 may determine the to-be-run target virtual machine according to a load balancing policy. The target virtual machine may be VM1, or may be VM2.

Processes in which the execution flow of the processor is switched from the host back to the original VM1 and to the new VM2 are the same. In the embodiments of this disclosure, the original VM1 and the new VM2 may both be defined as target virtual machines. In other words, the target virtual machine is a to-be-run virtual machine in the computing device. The virtual machine switching process is exemplarily described below by using the target virtual machine as an example.

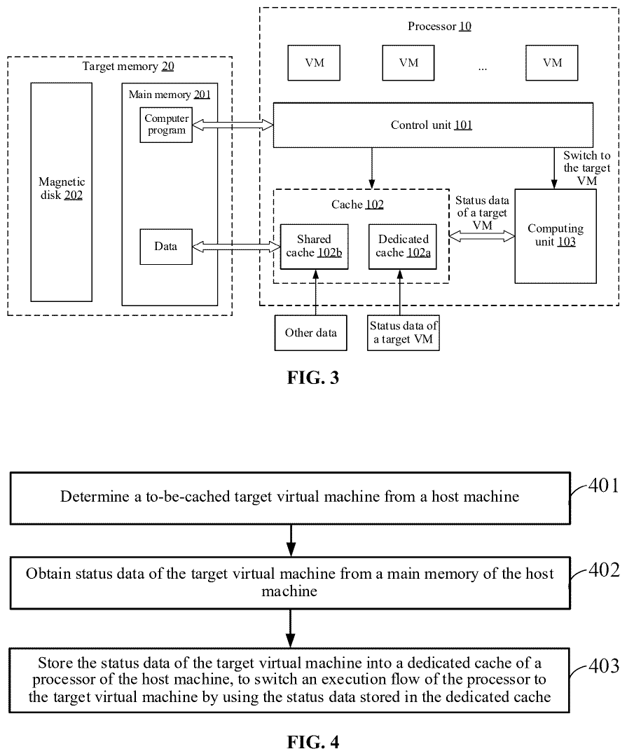

As shown in FIG. 3, the processor 10, may obtain status data of a to-be-run target virtual machine from the dedicated cache 102a in response to a virtual machine scheduling event. The virtual machine scheduling event is an event instructing the execution flow of the processor to switch from the host to a virtual machine, and may be sent by the operating system running in the processor. The to-be-run target virtual machine may be determined by the operating system.

In some embodiments, the processor 10 may determine the to-be-run target virtual machine according to a set virtual machine scheduling policy. For example, the to-be-run target virtual machine may be determined based on a task priority of the virtual machine. For example, a virtual machine having the highest task priority may be selected from the virtual machines of the computing device as the to-be-run target virtual machine. After the target virtual machine is determined, the virtual machine scheduling event may be generated. The virtual machine scheduling event is used for instructing the execution flow of the processor to switch from the host to the target virtual machine.

In some implementations, the processor 10 may obtain the status data of the to-be-run target virtual machine from the dedicated cache 102a in response to the virtual machine scheduling event. In an embodiment, the processor 10 may switch the execution flow of the processor from a host of the target virtual machine to the target virtual machine. For example, the processor 10 may execute a virtual machine enter instruction (such as the vmenter instruction) that uses the target virtual machine as the to-be-entered virtual machine, to switch the execution flow of the processor from the host to the target virtual machine. For example, the processor 10 may run the target virtual machine based on the status data of the target virtual machine.

In this embodiment, a dedicated cache dedicated to caching status data of a virtual machine is disposed in a cache of a processor. Based on the dedicated cache, when an execution flow of the processor is switched from a host to a target virtual machine, status data of the target virtual machine can be read from the dedicated cache of the processor. In comparison with the conventional method of reading status data of a virtual machine from a main memory during virtual machine switching, a speed of reading the status data of the virtual machine from the cache is higher. Therefore, reading the status data from the dedicated cache of the processor during virtual machine switching helps improve virtual machine switching efficiency.

In addition, setting the cache dedicated to storing the status data of the virtual machine in the processor can prevent the status data of the virtual machine from being covered by other data during execution of the computer program, and can reduce a probability that the processor reads the status data of the virtual machine from the main memory.

In the embodiments of this disclosure, the execution flow of the processor is not limited to being operated before the host. In some embodiments, the execution flow is in a virtual machine state before the execution flow is on the host. The virtual machine may be the foregoing target virtual machine, or may be another virtual machine. A process of switching from the virtual machine to the host is exemplarily described below by using an example in which the execution flow of the processor is located in a first virtual machine before being switched to the host. The first virtual machine is the to-be-run target virtual machine; or is a virtual machine other than the to-be-run target virtual machine.

The processor 10 may remove the first virtual machine in the execution flow of the processor from the execution flow in response to a virtual machine exit event. For example, the processor 10 may execute, in response to the virtual machine exit event, a virtual machine exit instruction (such as the vmexit instruction) using the first virtual machine as a to-be-exited virtual machine, to remove the first virtual machine from the execution flow of the processor.

The virtual machine exit event may be sent by the operating system running in the processor 10, or may be sent by another virtual machine. In some embodiments, the operating system in the processor 10 may send an interrupt request based on a set interrupt period. Correspondingly, the virtual machine exit event may be implemented as that: the interrupt request is received. In an embodiment, the first virtual machine in the execution flow of the processor may be removed from the execution flow in response to the interrupt request.

In some other embodiments, if the first virtual machine shares a logical core with another virtual machine, the another virtual machine that shares the logical core with the first virtual machine may send an inter-core interrupt request to the first virtual machine. Correspondingly, the virtual machine exit event may be implemented as that: the inter-core interrupt request is received. For example, the processor 10 may remove the first virtual machine in the execution flow of the processor from the execution flow in response to the inter-core interrupt request.

In an embodiment, the processor 10 may obtain status data of the first virtual machine. The status data of the first virtual machine is status data when the first virtual machine exits the execution flow, and may include: status data of a register, a main memory page table corresponding to the first virtual machine, and the like when the first virtual machine exits the execution flow.

Correspondingly, the processor 10 may read the status data of the register of the host and the main memory page table corresponding to the first virtual machine when the first virtual machine exits the execution flow of the processor, and use the status data of the register of the host and the main memory page table corresponding to the first virtual machine as the status data of the first virtual machine.

For example, the processor 10 may write the status data of the first virtual machine into the dedicated cache 102a. For a specific implementation of writing the status data of the first virtual machine into the dedicated cache 102a, refer to the foregoing related content of writing the status data of the target virtual machine into the dedicated cache. Details are not described herein again.

The processor 10 may switch the execution flow to the host of the first virtual machine. Correspondingly, the host may execute the instruction. Specific content of the instruction executed by the host is not limited in the embodiments of this disclosure. In some embodiments, the host may detect whether there is a to-be-executed instruction in a host process; and if there is a to-be-executed instruction, the host invokes the host process to execute the to-be-executed instruction. After the host executes the to-be-executed instruction, the processor 10 may determine the target virtual machine from the computing device according to the virtual machine scheduling policy. Correspondingly, if there is no to-be-executed instruction in the host process, the processor 10 may determine the target virtual machine from the computing device according to the virtual machine scheduling policy. For related content of determining the target virtual machine from the computing device according to the virtual machine scheduling policy, refer to the foregoing related content. Details are not described herein again.

In some implementations, the processor 10 may generate a virtual machine scheduling event for switching the execution flow of the processor to the target virtual machine. For an implementation in which the processor 10 switches the execution flow to the target virtual machine in response to the virtual machine scheduling event, refer to related content in the foregoing embodiment, and details are not described herein again.

The target virtual machine may be the first virtual machine, or may be a virtual machine (defined as a second virtual machine) other than the first virtual machine in the computing device.

In some embodiments, the target virtual machine is the second virtual machine. Before status data of the second virtual machine is obtained from the dedicated cache 102a, the status data of the second virtual machine has been pre-stored into the dedicated cache 102a. Correspondingly, before the virtual machine scheduling event is responded, the status data of the second virtual machine may further be read from the main memory, and the status data of the second virtual machine is written into the dedicated cache 102a. Because the status data of the second virtual machine is pre-stored into the dedicated cache before the processor responds to the virtual machine scheduling event, the status data of the second virtual machine is read from the dedicated cache of the processor during switching to the second virtual machine, helping improve the virtual machine switching efficiency.

For a specific implementation of reading the status data of the second virtual machine from the main memory and writing the status data of the second virtual machine into the dedicated cache, refer to related content of reading the status data of the target virtual machine from the main memory and writing the status data of the target virtual machine into the dedicated cache in the foregoing embodiments. Details are not described herein again.

In some other embodiments, if the processor 10 does not fetch the status data of the second virtual machine from the dedicated cache 102a, the processor 10 may read the status data of the second virtual machine from the main memory; and switch the execution flow of the processor to the second virtual machine based on the status data of the second virtual machine. For example, the processor 10 may alternatively write the status data of the second virtual machine into the dedicated cache 102a, to subsequently directly read the status data of the second virtual machine from the dedicated cache for virtual machine switching.

In addition to the foregoing system embodiments, the embodiments of this embodiment of this disclosure further provide a data storage method and a virtual machine switching method. The following exemplarily describes the data storage method and the virtual machine switching method provided in the embodiments of this disclosure.

FIG. 4 is a schematic flowchart of a data storage method according to an embodiment of this disclosure. As shown in FIG. 4, the data processing method mainly includes steps 401 to 403.

401: Determine a to-be-cached target virtual machine from a host.

402: Obtain status data of the target virtual machine from a main memory of the host.

403: Store the status data of the target virtual machine into a dedicated cache of a processor of the host, to switch an execution flow of the processor to the target virtual machine by using the status data stored in the dedicated cache.

For descriptions about an implementation form of the dedicated cache, refer to related content in the foregoing embodiments of the computing device, and details are not described herein again. In this embodiment, the dedicated cache is dedicated to storing status data of a virtual machine.

To implement VM switching acceleration, the to-be-cached target virtual machine may be determined from the host based on the dedicated cache. The to-be-cached target virtual machine is a virtual machine whose status data needs to be stored in the dedicated cache.

In this embodiment, a specific implementation of determining the to-be-cached target virtual machine is not limited. In some embodiments, according to a set cache management policy, the target virtual machine may be determined from virtual machines deployed on the computing device. For example, based on switching frequencies of the virtual machines in the computing device, a virtual machine whose switching frequency meets a set cache condition may be selected from the virtual machines deployed on the computing device as the to-be-cached target virtual machine. The cache condition corresponding to the switching frequency may be implemented as that: the switching frequency is greater than or equal to a set frequency threshold. Correspondingly, a virtual machine whose switching frequency is greater than or equal to the set frequency threshold may be selected from the virtual machines deployed on the computing device as the to-be-cached target virtual machine.

Alternatively, for the switching frequency, the set cache condition may be implemented as that: a virtual machine whose switching frequency is the highest switching frequency among the virtual machines is selected. Correspondingly, the virtual machine having the highest switching frequency may be selected from the virtual machines deployed on the computing device as the to-be-cached target virtual machine.

In some other embodiments, a virtual machine whose number of use times meets a set cache condition may be selected from the virtual machines deployed on the computing device based on numbers of use times of the virtual machines in the computing device within a set time period, and used as the to-be-cached target virtual machine. The cache condition corresponding to the number of use times may be implemented as that: the number of use times within the set time period is greater than or equal to a set number of times threshold. Correspondingly, a virtual machine whose number of use times in the set time period is greater than or equal to the set number of times threshold may be selected from the virtual machines deployed on the computing device as the to-be-cached target virtual machine.

Certainly, in some other embodiments, all virtual machines deployed on the computing device may alternatively be used as to-be-cached target virtual machines; or any virtual machine in the computing device is used as the to-be-cached target virtual machine.

The foregoing implementations of determining the to-be-cached target virtual machine shown in the foregoing embodiment is merely an exemplary description, and does not constitute a limitation.

For the to-be-cached target virtual machine, the status data of the target virtual machine may be obtained from the target memory. For example, the status data of the target virtual machine may be obtained from the main memory.

In the embodiments of this disclosure, status data of a virtual machine refers to data required for running of the virtual machine, and includes, but is not limited to: status data of a register, a main memory page table of the virtual machine, and the like during running of the virtual machine. In some processor architectures, the status data of a virtual machine may be implemented as VMCS. In some other processor architectures, the status data of a virtual machine may be implemented as a context of a processor, and the like.

In some embodiments, a main memory address corresponding to the target virtual machine may be determined based on an identifier of the target virtual machine. The main memory address may be a virtual address of a host. The status data of the target virtual machine is stored in the main memory address corresponding to the target virtual machine. Correspondingly, the status data of the target virtual machine may be read from the main memory based on the main memory address corresponding to the target virtual machine.

For example, the status data of the target virtual machine may be stored in the dedicated cache. In this way, when the execution flow of the processor is subsequently switched from the host to the target virtual machine, the status data of the target virtual machine can be directly read from the dedicated cache, helping improve the virtual machine switching efficiency.

In the embodiments of this disclosure, when the status data of the target virtual machine is stored into the dedicated cache, a target cache space may be determined from the dedicated cache, and the status data of the target virtual machine is written into the target cache space.

In some embodiments, an idle cache space from the dedicated cache may be determined as the target cache space.

In some other embodiments, there may be no idle cache space in the dedicated cache. Correspondingly, the processor 10 may determine a to-be-replaced cache space from the dedicated cache as the target cache space according to a set cache replacement algorithm. Certainly, the implementation of determining the to-be-replaced cache space by using a cache replacement algorithm is also applicable to a case in which there is an idle cache space stored in the dedicated cache. For descriptions about the cache replacement algorithm, refer to related content in the foregoing embodiments, and details are not described herein again.

After determining the target cache space, the status data of the target virtual machine may be written into the target cache space.

Because the dedicated cache is a dedicated cache for the status data of the virtual machine, a processor instruction for managing the dedicated cache may be added to the processor, for example, the instruction “vmcs_cache_addr idx addr” shown in the foregoing embodiment. After the to-be-cached target virtual machine and the target cache space in the dedicated cache are determined based on the processor instruction for managing the dedicated cache, the main memory address of the target virtual machine and the identifier of the target cache space may be written into the processor instruction according to a format of the processor instruction for managing the dedicated cache. The processor instruction may include: the main memory address of the status data of the target virtual machine and the identifier of the target cache space.

In an implementation, the processor instruction for managing a dedicated cache may be executed, and the status data of the target virtual machine is read from the main memory according to the main memory address included in the processor instruction when executing the processor instruction. For example, the status data of the target virtual machine may be read from a main memory space whose main memory address is [addr, addr+Y kB].

In an implementation, when the processor instruction is executed, the status data of the target virtual machine may be written into the cache space corresponding to the identifier of the target cache space in the dedicated cache. For example, the status data of the target virtual machine may be written into a cache space corresponding to an identifier of the target cache space in the dedicated cache based on a data structure corresponding to the dedicated cache. The data structure corresponding to the dedicated cache may be VMCS.

Because the status data of the target virtual machine is stored in the dedicated cache of the processor, when the execution flow of the processor is switched from the host to the target virtual machine, the status data of the target virtual machine can be read from the dedicated cache, helping improve the virtual machine switching efficiency.

The virtual machine switching process provided in the embodiments of this disclosure is exemplarily described below. In the embodiments of this disclosure, a virtual machine switching scenario may include: the execution flow of the processor exits from VM1, and is switched to a host on which VM1 is located; and then, is switched back from the host to VM1. Certainly, the virtual machine switching scenario may alternatively include: the execution flow of the processor exits from VM1, and is switched to a host on which VM1 is located; and then, is switched from the host to VM2. Whether the execution flow of the processor is switched from the host side back to VM1 or to VM2 is specifically determined by the operating system scheduling in the processor.

Processes in which the execution flow of the processor is switched from the host back to the original VM1 and to the new VM2 are the same. In the embodiments of this disclosure, the original VM1 and the new VM2 may both be defined as target virtual machines. In other words, the target virtual machine is a to-be-run virtual machine in the computing device. The virtual machine switching process is exemplarily described below by using the target virtual machine as an example.

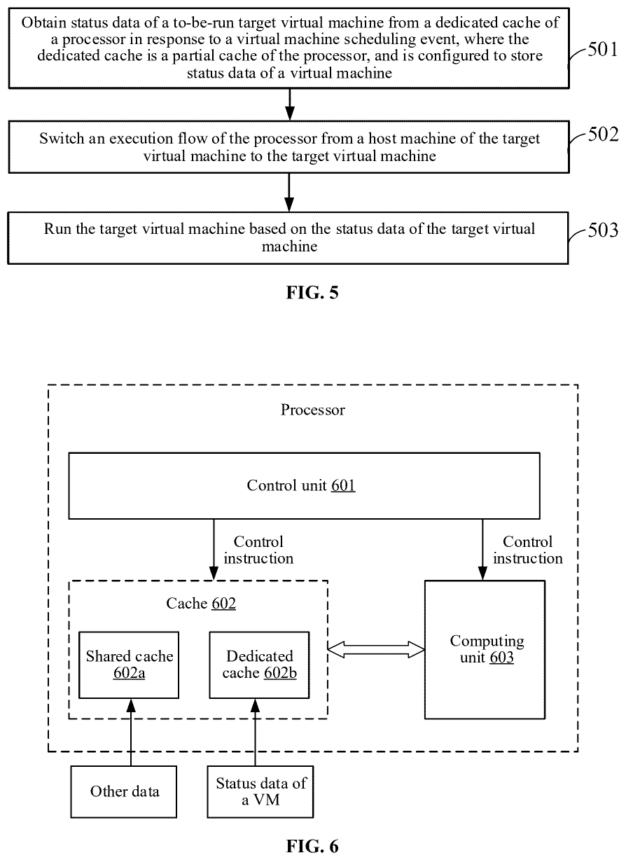

FIG. 5 is a schematic flowchart of a virtual machine switching method according to an embodiment of this disclosure. As shown in FIG. 5, the virtual machine switching method mainly includes steps 501 to 503.

501: Obtain status data of a to-be-run target virtual machine from a dedicated cache of a processor in response to a virtual machine scheduling event, where the dedicated cache is a partial cache of the processor, and is configured to store status data of a virtual machine.

502: Switch an execution flow of the processor from a host of the target virtual machine to the target virtual machine.

503: Run the target virtual machine based on the status data of the target virtual machine.

In this embodiment, the processor of the host includes the dedicated cache dedicated to storing status data of a virtual machine. For an implementation form and a disposing position of the dedicated cache, refer to related content in the foregoing embodiments of the computing device, and details are not described herein again.

Based on the dedicated cache, in step 501 of this embodiment, the status data of the to-be-run target virtual machine can be obtained from the dedicated cache in response to the virtual machine scheduling event. The virtual machine scheduling event is an event instructing the execution flow of the processor to switch from the host to a virtual machine, and may be sent by the operating system running in the processor. The to-be-run target virtual machine may be determined by the operating system.

In some embodiments, the to-be-run target virtual machine may be determined according to a set virtual machine scheduling policy. For example, the to-be-run target virtual machine may be determined based on a task priority of the virtual machine. For example, a virtual machine having the highest task priority may be selected from the virtual machines of the computing device as the to-be-run target virtual machine. Alternatively, the to-be-run target virtual machine may be determined according to a load balancing policy. The to-be-run target virtual machine herein may be any virtual machine that has stored status data in FIG. 4.

After the target virtual machine is determined, the virtual machine scheduling event may be generated. The virtual machine scheduling event is used for instructing the execution flow of the processor to switch from the host to the target virtual machine.

In an implementation, the status data of the to-be-run target virtual machine may be obtained from the dedicated cache in response to the virtual machine scheduling event. In an embodiment, in step 502, the execution flow of the processor may be switched from a host of the target virtual machine to the target virtual machine. For example, a virtual machine enter instruction (such as vmenter) that uses the target virtual machine as the to-be-entered virtual machine may be executed, to switch the execution flow of the processor from the host to the target virtual machine. For example, the target virtual machine may be run based on the status data of the target virtual machine.

In this embodiment, when the execution flow of the processor is switched from the host to the target virtual machine, the status data of the target virtual machine can be read from the dedicated cache of the processor. In comparison with the conventional method of reading status data of a virtual machine from a main memory during virtual machine switching, a speed of reading the status data of the virtual machine from the cache is higher. Therefore, reading the status data from the dedicated cache of the processor during virtual machine switching helps improve virtual machine switching efficiency.

In addition, setting the cache dedicated to storing the status data of the virtual machine in the processor can prevent the status data of the virtual machine from being covered by other data during execution of the computer program, and can reduce a probability that the processor reads the status data of the virtual machine from the main memory.

In the embodiments of this disclosure, the execution flow of the processor is not limited to being operated before the host. In some embodiments, the execution flow is in a virtual machine state before the execution flow is on the host. The virtual machine may be the foregoing target virtual machine, or may be another virtual machine. A process of switching from the virtual machine to the host is exemplarily described below by using an example in which the execution flow of the processor is located in a first virtual machine before being switched to the host. The first virtual machine is the to-be-run target virtual machine; or is a virtual machine other than the to-be-run target virtual machine.

In some embodiments, the first virtual machine in the execution flow of the processor may exit from the execution flow in response to a virtual machine exit event. For example, in response to the virtual machine exit event, a virtual machine exit instruction (such as the vmexit instruction) using the first virtual machine as a to-be-exited virtual machine may be executed, to remove the first virtual machine from the execution flow of the processor.

The virtual machine exit event may be sent by the operating system running in the processor, or may be sent by another virtual machine. In some embodiments, the operating system in the processor may send an interrupt request based on a set interrupt period. Correspondingly, the virtual machine exit event may be implemented as that: the interrupt request is received. For example, the first virtual machine in the execution flow of the processor may exit from the execution flow in response to the interrupt request.

In some other embodiments, if the first virtual machine shares a logical core with another virtual machine, the another virtual machine that shares the logical core with the first virtual machine may send an inter-core interrupt request to the first virtual machine. Correspondingly, the virtual machine exit event may be implemented as that: the inter-core interrupt request is received. For example, the first virtual machine in the execution flow of the processor may exit from the execution flow in response to the inter-core interrupt request.

In an implementation, status data of the first virtual machine may be obtained. The status data of the first virtual machine is status data when the first virtual machine exits the execution flow, and may include: status data of a register, a main memory page table corresponding to the first virtual machine, and the like when the first virtual machine exits the execution flow.

Correspondingly, the status data of the register of the host and the main memory page table corresponding to the first virtual machine when the first virtual machine exits the execution flow of the processor may be read, and the status data of the register of the host and the main memory page table corresponding to the first virtual machine are used as the status data of the first virtual machine.

For example, the status data of the first virtual machine may be written into the dedicated cache. For a specific implementation of writing the status data of the first virtual machine into the dedicated cache, refer to the foregoing related content of writing the status data of the target virtual machine into the dedicated cache. Details are not described herein again.

In an implementation, the execution flow may be switched to the host of the first virtual machine. Correspondingly, the host may execute the instruction. Specific content of the instruction executed by the host is not limited in the embodiments of this disclosure. In some embodiments, the host may detect whether there is a to-be-executed instruction in a host process; and if there is a to-be-executed instruction, the host invokes the host process to execute the to-be-executed instruction. After the host executes the to-be-executed instruction, the target virtual machine may be determined from the computing device according to the virtual machine scheduling policy. Correspondingly, if there is no to-be-executed instruction in the host process, the target virtual machine may be determined from the computing device according to the virtual machine scheduling policy. For related content of determining the target virtual machine from the computation device according to the virtual machine scheduling policy, refer to the foregoing related content. Details are not described herein again.

For example, a virtual machine scheduling event for switching the execution flow of the processor to the target virtual machine may be generated. For an implementation of switching the execution flow to the target virtual machine in response to the virtual machine scheduling event, refer to related content in the foregoing embodiments, and details are not described herein again.

The target virtual machine may be the first virtual machine, or may be a virtual machine (defined as a second virtual machine) other than the first virtual machine in the computing device.

In some embodiments, the target virtual machine is the second virtual machine. Before status data of the second virtual machine is obtained from the dedicated cache, the status data of the second virtual machine has been pre-stored into the dedicated cache. Correspondingly, before the virtual machine scheduling event is responded, the status data of the second virtual machine may further be read from the main memory, and the status data of the second virtual machine is written into the dedicated cache. Because the status data of the second virtual machine is pre-stored into the dedicated cache before the processor responds to the virtual machine scheduling event, the status data of the second virtual machine is read from the dedicated cache of the processor during switching to the second virtual machine, helping improve the virtual machine switching efficiency.

In some other embodiments, if the status data of the second virtual machine is not read from the dedicated cache, the status data of the second virtual machine may be read from the main memory; and the execution flow of the processor is switched to the second virtual machine based on the status data of the second virtual machine. For example, the status data of the second virtual machine may alternatively be written into the dedicated cache, for subsequently directly reading the status data of the second virtual machine from the dedicated cache for virtual machine switching.

For a specific implementation of reading the status data of the second virtual machine from the main memory and writing the status data of the second virtual machine into the dedicated cache, refer to related content of reading the status data of the target virtual machine from the main memory and writing the status data of the target virtual machine into the dedicated cache in the foregoing embodiment in FIG. 4. Details are not described herein again.

It should be noted that various steps of the method provided in the foregoing embodiments may be performed by a same device, or may be performed by different devices. For example, steps 401 and 402 may be performed by a device A; for another example, step 401 may be performed by a device A, and step 402 may be performed by a device B; and the like.

In addition, some procedures described in the foregoing embodiments and accompanying drawings include a plurality of operations performed in a particular order. However, it should be clearly learned that these operations may not be performed in the order in which these operations are performed in the specification or may be performed concurrently. Sequence numbers, such as 401 and 402, of the operations are merely used to distinguish between different operations, and the sequence numbers do not represent any execution order. In addition, these procedures may include more or fewer operations, and these operations may be performed in an order or may be performed concurrently.

Corresponding, an embodiment of this disclosure further provides a computer-readable storage medium storing computer instructions. When the computer instructions are executed by one or more processors, the one or more processors are enabled to perform steps in the foregoing data storage method and/or virtual machine switching method.

FIG. 6 is a schematic diagram of a structure of a processor according to an embodiment of this disclosure. As shown in FIG. 6, the processor may include: a control unit 601, a cache 602, and a computing unit 603. The control unit 601, the cache 602, and the computing unit 603 are electrically connected to each other. For descriptions of the control unit, the cache, and the computing unit, refer to related content in FIG. 1, and details are not described herein again.

In this embodiment, the cache 602 includes a dedicated cache 602a and a shared cache 602b. For descriptions of implementation forms and deployment positions of the dedicated cache 602a and the shared cache 602b, refer to related content in FIG. 1, and details are not described herein again.

For the processor provided in FIG. 6, when the processor is deployed on an electronic device, the dedicated cache 602a is dedicated to storing status data of one or more virtual machines deployed on the electronic device. The shared cache is configured to store other data required for running the computer program on the electronic device than the status data of the virtual machine.

In this embodiment, the control unit 601 may be coupled to the cache 602 and the computing unit 603, and is configured to invoke, from a memory of an electronic device on which the processor is deployed, a computer program in the memory and run the computer program, to enable the electronic device to perform steps in the foregoing data storage method and/or virtual machine switching method, to implement virtual machine switching acceleration.

In the embodiments of this disclosure, a dedicated cache dedicated to caching status data of a virtual machine is disposed in a cache of a processor. Based on the dedicated cache, when an execution flow of the processor is switched from a host to a target virtual machine, status data of the target virtual machine can be read from the dedicated cache of the processor. In comparison with the conventional method of reading status data of a virtual machine from a main memory during virtual machine switching, a speed of reading the status data of the virtual machine from the cache is higher. Therefore, reading the status data from the dedicated cache of the processor during virtual machine switching helps improve virtual machine switching efficiency.

It should be further noted that, user information (including but not limited to user equipment information, user personal information, and the like) and data (including but not limited to data for analysis, stored data, displayed data, and the like) in this disclosure are all information and data that are authorized by a user or that are fully authorized by all parties, and related data needs to be collected, used, and processed by complying with relevant laws, regulations, and standards of relevant countries and regions. In addition, a corresponding operation entry is provided for the user to select to authorize or reject.

In the embodiments of this disclosure, the memory is configured to store a computer program, and may be configured to store various other data to support operations on a device on which the memory is deployed. The processor may execute the computer program stored in the memory, to implement corresponding control logic. The memory may be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

In the embodiments of this disclosure, the processor may be any hardware processing device capable of executing logic of the foregoing method. For example, the processor may be a central processing unit (CPU), a graphics processing unit (GPU), or a microcontroller unit (MCU); or a programmable device such as a field programmable gate array (FPGA), a programmable array logic (PAL) device, a general array logic (GAL) device, or a complex programmable logic device (CPLD); or an application-specific integrated circuit (ASIC) chip; or an advanced reduced instruction set computer (RISC) processor (ARM), a system on chip (SoC), or the like, but is not limited thereto.

In the embodiments of this disclosure, the computing device may further include: a communication component. The communication component is configured to facilitate wired or wireless communication between a device on which the communication component is disposed and another device. The device on which the communication component is disposed may access a wireless network based on a communication standard, such as wireless fidelity (Wi-Fi), 2G or 3G, 4G, 5G, or a combination thereof. In an exemplary embodiment, the communication component receives a broadcast signal or broadcast related information from an external broadcast management system through a broadcast channel. In an exemplary embodiment, the communication component may alternatively be implemented based on a near field communication (NFC) technology, a radio frequency identification (RFID) technology, an infrared data association (IrDA) technology, an ultra wideband (UWB) technology, a Bluetooth (BT) technology, or another technology.

In the embodiments of this disclosure, the computing device may further include: a display component. The display component may include a liquid crystal display (LCD) and a touch panel (TP). If the display component includes a touch panel, the display component may be implemented as a touchscreen, to receive an input signal from the user. The touch panel includes one or more touch sensors, to sense touching, sliding, and gestures on the touch panel. The touch sensor may not only sense the boundary of touching or sliding operations, but also detect duration and pressure related to the touching or sliding operations.

In the embodiments of this disclosure, the computing device may further include: a power supply component. The power supply component is configured to supply power to various components of a device on which the power supply component is disposed. The power supply component may include a power supply management system, one or more power supplies, and other components associated with generating, managing, and allocating power for the device on which the power supply component is disposed.

In the embodiments of this disclosure, the computing device may further include: an audio component. The audio component may be configured to output and/or input an audio signal. For example, the audio component includes a microphone (MIC). When a device on which the audio component is disposed is in an operating mode, such as a call mode, a record mode, or a speech recognition mode, the microphone is configured to receive an external audio signal. The received audio signal may be further stored in a memory or sent through the communication component. In some embodiments, the audio component further includes a speaker, configured to output an audio signal. For example, for a device having a speech interaction function, speech interaction with the user may be implemented by using the audio component.

It should be noted that, descriptions of “first”, “second”, and the like in the specification are used to distinguish between different messages, devices, modules, and the like, and do not indicate a sequence and do not limit that “first” and “second” are different types either.

A person skilled in the art needs to understand that the embodiments of this disclosure may be provided as a method, a system, or a computer program product. Therefore, this disclosure may use a form of entirely hardware embodiments, entirely software embodiments, or embodiments combining software and hardware aspects. In addition, this disclosure may use a form of a computer program product that is implemented on one or more computer-usable storage media (including but not limited to a magnetic disk memory, a compact disc read-only memory (CD-ROM), an optical memory, and the like) that include computer-usable program code.

This disclosure is described with reference to flowcharts and/or block diagrams of the method, the device (or system), and the computer program product according to the embodiments of this disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a special-purpose computer, an embedded processor, or a processor of any other programmable data processing device to generate a machine, so that the instructions executed by the computer or the processor of any other programmable data processing device generate an apparatus for implementing a specific function in one or more procedures in the flowcharts and/or in one or more blocks in the block diagrams.

These computer program instructions may alternatively be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program commands may also be loaded onto a computer or another programmable data processing device, so that a series of operations and operations are performed on the computer or the another programmable device, thereby generating computer-implemented processing. Therefore, the instructions executed on the computer or the another programmable device provide operations for implementing a specific function in one or more procedures in the flowcharts and/or in one or more blocks in the block diagrams.

In a typical configuration, the computing device includes one or more processors (such as CPUs), an input/output interface, a network interface, and a main memory.

The main memory may include a volatile memory in a computer-readable medium, a random access memory (RAM), and/or a non-volatile memory, such as a read-only memory (ROM) or a flash memory (Flash RAM). The main memory is an example of the computer-readable medium.

The storage medium of the computer is a readable storage medium, and may also be referred to as a readable medium. The readable storage medium includes non-volatile and volatile mediums, and removable and non-removable mediums, which may implement storage of information by using any method or technology. The information may be a computer-readable instruction, a data structure, a program module, or other data. Examples of the storage medium of the computer include, but are not limited to, a phase-change memory (PRAM), a static random-access memory (SRAM), a dynamic random-access memory (DRAM), another type of random-access memory (RAM), a read-only memory (ROM), an electrically erasable programmable read-only memory (EEPROM), a flash memory or another memory technique, a compact disc read-only memory (CD-ROM), a digital versatile disk (DVD) or another optical storage, a magnetic cartridge tape, magnetic disk storage or another magnetic storage device or any other non-transmission medium, which may be configured to store information that can be accessed by a computing device. Based on the definitions in this specification, the computer-readable medium does not include transitory computer-readable media (transitory media), such as a modulated data signal and a carrier.

It should be further noted that, the terms “include”, “comprise”, or any variants thereof are intended to cover a non-exclusive inclusion. Therefore, a process, method, article, or device that includes a series of elements not only includes such elements, but also includes other elements not specified expressly, or may include inherent elements of the process, method, article, or device. Unless otherwise specified, an element limited by “include a/an . . . ” does not exclude other same elements existing in the process, the method, the article, or the device that includes the element.

The foregoing content is merely the embodiments of the present disclosure and is not intended to limit the protection scope of the present disclosure. For a person skilled in the art, various modifications and variations can be made to this disclosure. Any modification, equivalent replacement, or improvement made without departing from the spirit and principle of this disclosure shall fall within the scope of the claims of this disclosure.

1. A virtual machine switching method, comprising:
obtaining status data of a to-be-run target virtual machine from a dedicated cache of a processor in response to a virtual machine scheduling event, wherein the dedicated cache is a partial cache of the processor, and is configured to store status data of a virtual machine;
switching an execution flow of the processor from a host of the target virtual machine to the target virtual machine; and
running the target virtual machine based on the status data of the target virtual machine.

2. The method according to claim 1, further comprising:
causing a first virtual machine in the execution flow of the processor to exit the execution flow of the processor in response to a virtual machine exit event;
obtaining status data of the first virtual machine, wherein the status data of the first virtual machine is status data when the first virtual machine exits the execution flow of the processor;
writing the status data of the first virtual machine into the dedicated cache;
switching the execution flow of the processor to a host of the first virtual machine, so that the host executes an instruction; and
determining a to-be-run target virtual machine according to a virtual machine scheduling policy after the host executes the instruction.

3. The method according to claim 2, wherein the obtaining status data of the first virtual machine comprises:
reading status data of a register of the host and a main memory page table of the first virtual machine when the first virtual machine exits the execution flow of the processor; and
using the status data of the register and the main memory page table of the first virtual machine as the status data of the first virtual machine.

4. The method according to claim 2, wherein the causing the first virtual machine in the execution flow of the processor to exit the execution flow of the processor comprises:
executing a virtual machine exit instruction using the first virtual machine as a to-be-exited virtual machine, to cause the first virtual machine to exit the execution flow of the processor.

5. The method according to claim 1, wherein the switching the execution flow of the processor from the host of the target virtual machine to the target virtual machine comprises:
executing a virtual machine enter instruction using the target virtual machine as a to-be-entered virtual machine, to switch the execution flow of the processor from the host to the target virtual machine.

6. The method according to claim 2, wherein the target virtual machine is the first virtual machine or a second virtual machine in the host; and
before responding to the virtual machine scheduling event, the method further comprises:
reading status data of the second virtual machine from a main memory of the host;
determining a target cache space from the dedicated cache; and
writing the status data of the second virtual machine into the target cache space.

7. The method according to claim 6, wherein the determining the target cache space from the dedicated cache comprises:
determining an idle cache space from the dedicated cache as the target cache space;
or
determining a to-be-replaced cache space from the dedicated cache as the target cache space according to a set cache replacement algorithm.

8. The method according to claim 6, wherein the reading status data of the second virtual machine from the main memory of the host comprises:
executing a processor instruction for managing the dedicated cache, wherein the processor instruction comprises a main memory address of the status data of the second virtual machine and an identifier of the target cache space; and
reading the status data of the second virtual machine from the main memory based on the main memory address during executing the processor instruction; and
the writing the status data of the second virtual machine into the target cache space comprises:
writing the status data of the second virtual machine into a cache space corresponding to the identifier of the target cache space in the dedicated cache based on a data structure corresponding to the dedicated cache during executing the processor instruction.

9. A data storage method, wherein a processor of a host comprises a dedicated cache, wherein the dedicated cache is configured to store status data of a virtual machine; and the method comprises:
determining a to-be-cached target virtual machine from the host;
obtaining status data of the target virtual machine from a main memory of the host; and
storing the status data of the target virtual machine into the dedicated cache, in a way that the status data stored in the dedicated cache is available to switch an execution flow of the processor to the target virtual machine.

10. A computing device, wherein one or more virtual machines are deployed on the computing device; the computing device comprises a processor, the processor comprises a control unit, a computing unit, and a cache; and the computing device further comprises a target memory, configured to store a computer program;
the cache comprises a dedicated cache and a shared cache; the dedicated cache is configured to store status data of the virtual machines; and the shared cache is configured to execute other data required for executing the computer program than the status data of the virtual machines; and
the control unit is coupled to the computing unit, the cache, and the target memory, and the control unit is configured to: execute the computer program; write the other data into the shared cache when executing the computer program; and perform operations comprising:
obtaining status data of a to-be-run target virtual machine from the dedicated cache of the processor in response to a virtual machine scheduling event;
switching an execution flow of the processor from a host of the target virtual machine to the target virtual machine; and
running the target virtual machine based on the status data of the target virtual machine.

11. The device according to claim 10, wherein the dedicated cache is a first-level cache of the processor.

12. A processor, comprising: a control unit, a computing unit, and a cache, wherein the cache comprises: a dedicated cache and a shared cache; when the processor is deployed in an electronic device, the dedicated cache is configured to cache status data of one or more virtual machines deployed on the electronic device; and the shared cache is configured to cache other data required for running a computer program on the electronic device other than the status data of the virtual machines; and
the control unit is coupled to the cache and the computing unit, and the control unit is configured to invoke, from a memory of the electronic device on which the processor is deployed, a computer program stored in the memory and run the computer program, to enable the electronic device to perform steps of the method according to claim 1.

13. A computer-readable storage medium storing computer instructions, wherein when the computer instructions are executed by one or more processors, the one or more processors are enabled to perform steps of the method according to any claim 1.

14. The device according to claim 10, wherein the operations further comprising:
causing a first virtual machine in the execution flow of the processor to exit the execution flow of the processor in response to a virtual machine exit event;
obtaining status data of the first virtual machine, wherein the status data of the first virtual machine is status data when the first virtual machine exits the execution flow of the processor;
writing the status data of the first virtual machine into the dedicated cache;
switching the execution flow of the processor to a host of the first virtual machine, so that the host executes an instruction; and
determining a to-be-run target virtual machine according to a virtual machine scheduling policy after the host executes the instruction.

15. The device according to claim 14, wherein the obtaining status data of the first virtual machine comprises:
reading status data of a register of the host and a main memory page table of the first virtual machine when the first virtual machine exits the execution flow of the processor; and
using the status data of the register and the main memory page table of the first virtual machine as the status data of the first virtual machine.

16. The device according to claim 14, wherein the causing the first virtual machine in the execution flow of the processor to exit the execution flow of the processor comprises:
executing a virtual machine exit instruction using the first virtual machine as a to-be-exited virtual machine, to cause the first virtual machine to exit the execution flow of the processor.

17. The device according to claim 10, wherein the switching the execution flow of the processor from the host of the target virtual machine to the target virtual machine comprises:
executing a virtual machine enter instruction using the target virtual machine as a to-be-entered virtual machine, to switch the execution flow of the processor from the host to the target virtual machine.

18. The device according to claim 14, wherein the target virtual machine is the first virtual machine or a second virtual machine in the host; and
before responding to the virtual machine scheduling event, the operations further comprise:
reading status data of the second virtual machine from a main memory of the host;
determining a target cache space from the dedicated cache; and
writing the status data of the second virtual machine into the target cache space.

19. The device according to claim 18, wherein the determining the target cache space from the dedicated cache comprises:
determining an idle cache space from the dedicated cache as the target cache space;
or
determining a to-be-replaced cache space from the dedicated cache as the target cache space according to a set cache replacement algorithm.

20. The device according to claim 18, wherein the reading status data of the second virtual machine from the main memory of the host comprises:
executing a processor instruction for managing the dedicated cache, wherein the processor instruction comprises a main memory address of the status data of the second virtual machine and an identifier of the target cache space; and
reading the status data of the second virtual machine from the main memory based on the main memory address during executing the processor instruction; and
the writing the status data of the second virtual machine into the target cache space comprises:
writing the status data of the second virtual machine into a cache space corresponding to the identifier of the target cache space in the dedicated cache based on a data structure corresponding to the dedicated cache during executing the processor instruction.
